(19) United States
(12) Patent Application Publication
(10) Pub. No.: US 2008/0199734 A1
(43) Pub. Date: Aug. 21, 2008

(54) PERPENDICULAR MAGNETIC RECORDING MEDIUM, MANUFACTURING METHOD THEREOF AND MAGNETIC RECORDING DEVICE

(75) Inventors: Antony Ajan, Kawasaki (JP); Toshio Sugimoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/023,338

(22) Filed: Jan. 31, 2008

(30) Foreign Application Priority Data
Feb. 15, 2007 (JP) 2007-035345

(51) Int. Cl. G11B 5/62; G11B 5/84

(52) U.S. Cl. 428/828; 427/127

(57) ABSTRACT

The thickness of the spacer layer is set in such as way as to obtain the anti-parallel magnetic coupling between two amorphous ferromagnetic layers in the perpendicular medium. When the thickness of the spacer layer is changed, the exchange field shows an oscillatory behavior and the highest values of the exchange fields are obtained at various thicknesses and indicates an anti-parallel exchange between them. A conventional recording medium applies the smallest thickness (1st APS) among the thicknesses corresponding to the exchange field maximum. On the other hand, the present invention applies the second smallest thickness (2nd APS) to obtain larger tolerance of spacer layer thickness and improved writability and enhanced recording performance.

### CROSS-REFERENCE TO RELATED APPLICATIONS

This application is based upon and claims the benefit of priority from the prior Japanese Patent Application No. 2007-035345, filed on Feb. 15, 2007, the entire contents of which are incorporated herein by reference.

### BACKGROUND OF THE INVENTION

1. Field of the Invention

The present invention relates to a perpendicular magnetic recording medium used in a hard disk drive and the like, a manufacturing method thereof and a magnetic recording device.

2. Description of the Related Art

A magnetic recording medium such as a hard disk and the like is used as a recording medium for large storage devices, servers, personal computers, game machines and the like. In order to satisfy the growing demands of storage, a high density magnetic recording medium is necessary and progress and studies of the perpendicular magnetic recording medium (method) is being conducted.

In the development of the perpendicular magnetic recording medium for higher densities, noise reduction and writability improvement are of at most importance. Here, the writability is an index term indicating how correctly the rewriting of the data can be performed. A technology aimed at reducing noise in the perpendicular media is disclosed in patent document 1 (Japanese Patent Application Laid-Open No. 2004-79043), patent document 2 (Japanese Patent Application Laid-Open No. 2004-272957) and the like. This technology includes a soft under layer structure having two ferromagnetic layers with a nonmagnetic metal layer in between and makes the direction of magnetization between the two ferromagnetic layers opposite (anti-parallel) to each other. The direction of magnetization between the two ferromagnetic layers can be made anti-parallel to each other utilizing RKKY (Ruderman-Kittel-Kasuya-Yosida) type interaction across the interfacial spacer layer. Such a structure of the soft under layer is called APS-SUL (anti-parallel structured soft under layer). The APS-SUL structure enables the effective return of the magnetic flux to the write head, reduces and nearly eliminates the wide area track erasure (WITE) of the magnetic bits and completely eliminates the domain spike noise from the soft under layer and hence is used for the implementation and further improvement of the recording density.

Conventionally, APS-SUL uses an amorphous cobalt zirconium tantalum (CoZrTa) layer or cobalt zirconium niobium (CoZrNb) layer as the ferromagnetic layer composing the soft under layer, and a ruthenium (Ru) layer as the nonmagnetic metal layer. In this case, a magnitude of an exchange magnetic field is about 40 Oe, which requires the ruthenium (Ru) layer to be about 0.4 nm to 0.6 nm (4 Å to 6 Å) in thickness.

However, it is very difficult to control the thickness of this thin ruthenium (Ru) layer having thickness about 0.4 nm to 0.6 nm. Further, when the thickness of ruthenium (Ru) layer is out of the above-described range, the direction of magnetization between the ferromagnetic layers becomes parallel, which eliminates the possibility of obtaining the APS-SUL structure. As a result, the noise will increase which may lower an S/N ratio. Moreover at higher density higher magnetization materials such FeCo alloys other than the Co alloy mentioned above will be used. In such a case the exchange field is larger, however the Ru thickness for which we get anti-parallel coupling is still further lower. Moreover as the exchange field increases the writability worsens. In other words, the APS-SUL structure is conventionally assumed to reduce the noise, in theory, however, technologies are needed to alleviate the other trade offs and improve the density of the perpendicular magnetic recording medium.

### SUMMARY OF THE INVENTION

According to an aspect of an embodiment, there is a perpendicular magnetic recording medium which has a soft under layer and a recording layer formed above the soft under layer. The soft under layer has an amorphous first ferromagnetic layer, a nonmagnetic metal layer formed on the first ferromagnetic layer and an amorphous second ferromagnetic layer formed on the nonmagnetic metal layer. A direction of magnetization between the first ferromagnetic layer and the second ferromagnetic layer is anti-parallel to each other. Further, a magnitude of an exchange magnetic field between the first ferromagnetic layer and the second ferromagnetic layer shows a plurality of peaks as a thickness of the nonmagnetic metal layer increases. The thickness of the nonmagnetic metal layer is defined to correspond to the second largest peak out of the plurality of peaks.

According to another aspect of an embodiment, there is a magnetic recording device provided with the above-described perpendicular magnetic recording medium. It is further provided with a magnetic head recording and reproducing information to and from the perpendicular magnetic recording medium.

According to further another aspect of an embodiment, there is a manufacturing method of a perpendicular magnetic recording medium, in which a soft under layer is formed, and then a recording layer is then formed above the soft under layer. In forming the soft under layer, an amorphous first ferromagnetic layer is formed, a nonmagnetic metal layer is formed on the first ferromagnetic layer, and then, an amorphous second ferromagnetic layer is formed on the nonmagnetic metal layer. The direction of magnetization between the first ferromagnetic layer and the second ferromagnetic layer is made to be anti-parallel to each other. Further, a magnitude of an exchange magnetic field between the first ferromagnetic layer and the second ferromagnetic layer shows a plurality of peaks as a thickness of the nonmagnetic metal layer increases. The thickness of the nonmagnetic metal layer is defined to correspond to the second largest peak out of the plurality of peaks.

### BRIEF DESCRIPTION OF THE DRAWINGS

FIG. 1 is a sectional view showing the structure of a perpendicular magnetic recording medium according to an embodiment of the present invention;

FIG. 2 is a view showing a method of making the perpendicular magnetic recording medium according to the embodiment of the present invention;

FIG. 3 is a graph showing the correlation between a thickness of a spacer layer 3 and a magnitude of the exchange magnetic field;

FIG. 4 is a graph showing the correlation between the thickness of the spacer layer 3 and the S/N ratio;

FIG. 5 is a graph showing the correlation between the thickness of the spacer layer 3 and the magnitude of the noise;

FIG. 6 is a graph showing a correlation between the thickness of the spacer layer 3 and the writability;

FIG. 7 is a graph showing the correlation between the thickness of the spacer layer 3 and the write core width; and

FIG. 8 is the view showing the structure of the magnetic recording device.

### DETAILED DESCRIPTION OF THE PREFERRED EMBODIMENTS

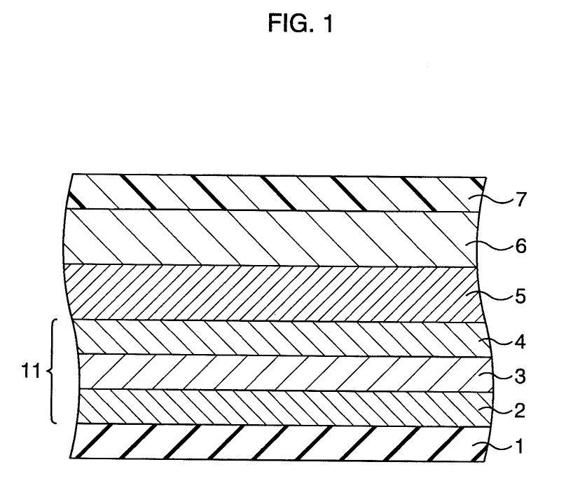

Hereinafter, embodiments according to the present invention will be specifically described with reference to the attached drawings. FIG. 1 is the sectional view showing the structure of the perpendicular magnetic recording medium according to the embodiment of the present invention.

In the embodiment, a disk-shaped substrate 1 is provided on which an amorphous ferromagnetic layer 2, a spacer layer 3 and an amorphous ferromagnetic layer 4 are sequentially formed, as shown in FIG. 1. The amorphous ferromagnetic layer 2, the spacer layer 3 and the amorphous ferromagnetic layer 4 compose the soft under layer 11.

As for the substrate 1, for example, a plastic substrate, a crystallized glass substrate, a tempered glass substrate, a silicon (Si) substrate, an aluminum alloy substrate or the likes are used.

As the amorphous ferromagnetic layers 2 and 4, amorphous ferromagnetic layers containing iron (Fe), cobalt (Co) and/or nickel (Ni) are formed. Further, amorphous ferromagnetic layer may contain chromium (Cr), boron (B), copper (Cu), titanium (Ti), vanadium (V), niobium (Nb), zirconium (Zr), platinum (Pt), palladium (Pd) and/or tantalum (Ta) therein. By suitable alloying of the above elements, it is possible to obtain a stabilized, corrosion free amorphous state or improving the magnetic characteristic of the amorphous ferromagnetic layers 2 and 4, compared to a case when containing only iron (Fe), cobalt (Co) and/or nickel (Ni) therein. Further, there may be contained aluminum (Al), silicon (Si), hafnium (Hf) and/or carbon (C) therein. Especially, when considering concentration of recording magnetic field, it is preferable to use a layer of soft magnetic material having a saturation magnetic flux density Bs of 1.0 T or more. Further, when considering writability with high transfer rate, it is preferable to use a layer having high frequency magnetic permeability. Specifically, for example, an iron cobalt boron (FeCoB) layer, an iron cobalt zirconium tantulum (FeCoZrTa), an iron cobalt zirconium niobium (FeCoZrNb) an iron cobalt boron chromium (FeCoBCr) layer, an iron silicon (FeSi) layer, an iron aluminum silicon (FeAlSi) layer, an iron tantalum carbon (FeTaC) layer, a cobalt zirconium niobium (CoZrNb) layer, a cobalt chromium niobium (CoCrNb) layer, a nickel iron niobium (NiFeNb) layer and the like can be cited. The amorphous ferromagnetic layers 2 and 4 can be formed by, for example, a plating method, a sputtering method, an evaporation method, a CVD (chemical vapor deposition) method or the like. When a DC sputtering method is applied, inside a chamber is set to be an argon (Ar) atmosphere of 0.5 Pa to 2 Pa, for example. Further, a thickness of each the amorphous ferromagnetic layers 2 and 4 is set to be, for example, 5 nm to 25 nm.

As a spacer layer 3, a nonmagnetic metal layer containing such as ruthenium (Ru), and/or copper (Cu) and/or chromium (Cr) is formed. Further, the spacer layer may be formed by rhodium (Rh), rhenium (Re) and/or rare-earth metal therein. The spacer layer 3 can be formed by, for example, a plating method, a sputtering method, an evaporation method, a CVD (chemical vapor deposition) method or the like. When a DC sputtering method is applied, inside a chamber is set to be an argon (Ar) atmosphere of 0.5 Pa to 2 Pa.

Further, in the embodiment, the thickness of the spacer layer 3 is set to a value when an anti-parallel magnetic coupling between the amorphous ferromagnetic layer 2 and the amorphous ferromagnetic layer 4 is formed. In other words, at that time, a direction of magnetization between the amorphous ferromagnetic layer 2 and the amorphous ferromagnetic layer 4 is opposite to each other and an anti-ferromagnetic coupling is appeared between the amorphous ferromagnetic layer 2 and the amorphous ferromagnetic layer 4. Furthermore, if the saturation magnetization of the amorphous ferromagnetic layer 2 is Mₛ₁, and the thickness thereof is t₁, and the saturation magnetization of the ferromagnetic layer 4 is Mₛ₂, and a thickness thereof is t₂, a following formula is satisfied: Mₛ₁×t₁=Mₛ₂×t₂. Accordingly, the residual magnetization of the soft under layer 11 is zero.

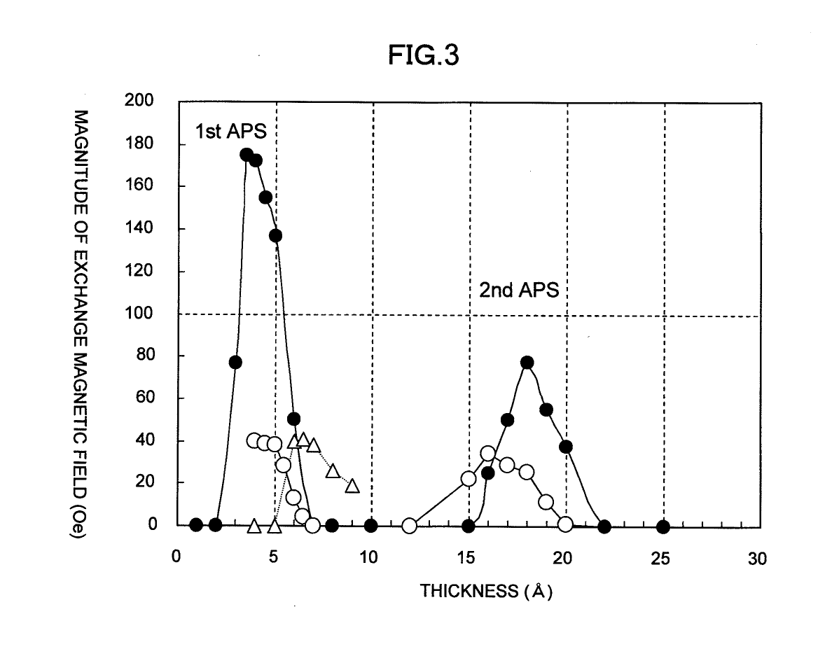

It should be noted that even when materials and thicknesses of the amorphous ferromagnetic layers 2 and 4 are determined, the thickness of the spacer layer 3 generating the above-described anti-ferromagnetic coupling can not be determined to be only one thickness range. There is a plurality of thickness ranges of the spacer layer 3 generating the anti-ferromagnetic coupling in accordance with the materials and the thicknesses of the amorphous ferromagnetic layers 2 and 4. Specifically, as shown in FIG. 3, when the thickness of the spacer layer 3 is changed, there appeared a plurality of thicknesses corresponding to peaks of a magnitude of an exchange magnetic field between the amorphous ferromagnetic layers 2 and 4. The appearance of these peak positions indicates the anti-ferromagnetic coupling between the amorphous ferromagnetic layers 2 and 4. Note that “”, “◯”, and “Δ” in FIG. 3 indicate a measurement result when an iron cobalt boron (FeCoB) layer, an iron cobalt boron chromium (FeCoBCr) layer and a cobalt niobium zirconium (CoNbZr) layer as each the amorphous ferromagnetic layers 2 and 4 are used, respectively. Further, a ruthenium (Ru) layer is used as the spacer layer 3 in each measurement.

A conventional recording medium applies the smallest thickness (1st APS) among the thicknesses corresponding to these peaks. This is to obtain a big exchange magnetic field. On the other hand, the embodiment applies the second smallest thickness (2nd APS). Comparing to a case when the smallest thickness is adopted, the adoption of the second smallest thickness will lower the magnitude of the exchange magnetic field a little, however, a the tolerance of spacer thickness is larger and width of the distribution becomes larger. This means that the thickness variation tolerance of the spacer layer 3 during the manufacturing process is larger. Further, the smaller the thickness of the spacer layer 3 is, the more difficult it is to control the thickness thereof. Therefore, the adoption of the second smallest thickness makes it easier to control the thickness and its tolerance of the spacer layer 3. Note that, the thickness of the 2nd APS is, in most cases, 1 nm or more, although may vary in accordance with the materials and the thicknesses of the amorphous ferromagnetic layers 2 and 4, the material of the spacer layer 3 and the like. Therefore, in the embodiment, the thickness of the spacer layer 3 (nonmagnetic metal layer) is set to be 1 nm or more.

Further, in the embodiment, an intermediate layer 5 is directly formed on the soft under layer 11. A thickness of the intermediate layer 5 is, for example, about 10 nm to 20 nm. As an intermediate layer 5, for example, a ruthenium (Ru) layer having a hexagonal close-packed (hcp) crystal structure is formed. Also as an intermediate layer 5, there may be formed a ruthenium (Ru)—X (X=cobalt (Co), chromium (Cr), iron (Fe), nickel (Ni), SiO₂, TiO₂, Cr—O and/or manganese (Mn)) alloy layer having a hexagonal close-packed (hcp) crystal structure in which ruthenium (Ru) is a major component. The intermediate layer 5 can be formed by, for example, a plating method, a sputtering method, an evaporation method, a CVD (chemical vapor deposition) method or the like. When a DC sputtering method is applied, an argon (Ar) atmosphere of 0.5 Pa to 8 Pa inside a chamber is used. Further, the thickness of the intermediate layer 5 is preferable to be in the range from 5 nm to 25 nm. When the thickness of the intermediate layer 5 is smaller than 5 nm, the noise may not be reduced sufficiently. On the other hand, when the thickness of the intermediate layer 5 is much larger than 25 nm, the writability may be lowered.

A recording layer 6 is formed on the intermediate layer 5. As a recording layer 6, for example, a ferromagnetic layer having cobalt (Co) and platinum (Pt) as major constituents is formed. Further, there may be the presence of the chemical elements such as chromium (Cr), boron (B), silicon dioxide (SiO₂), titanium dioxide (TiO₂), chromium dioxide (CrO₂), chromium oxide (CrO), Cr₂O₃, copper (Cu), titanium (Ti) and/or niobium (Nb) therein. Specifically, a cobalt chromium platinum (CoCrPt) layer having a grain boundary in which silicon dioxide (SiO₂) particles are dispersed is used. Further, the recording layer 6 may be composed of a plurality of layers. For example, when the recording layer 6 is composed of two layers, a lower layer is a cobalt chromium platinum (CoCrPt) layer having silicon dioxide (SiO₂) particles dispersed therein, and an upper layer is a cobalt chromium platinum boron (CoCrPtB) layer. The recording layer 6 is formed by, for example, a plating method, a sputtering method, an evaporation method, a CVD (chemical vapor deposition) method or the like. When a DC/RF sputtering method is applied, inside the chamber, an argon (Ar) atmosphere of 0.5 Pa to 6 Pa may be used. In this case, a gas containing oxygen of 2 to 5% may also be used as a co-sputtering gas. Further, the thickness of the recording layer 6 is set to be from 6 nm to 20 nm.

Then, a protective layer 7 is formed on the recording layer 6. As a protective layer 7, for example, an amorphous carbon layer, a carbon hydroxide layer, a carbon nitride layer, an aluminum oxide layer, a silicon nitride layer or the like are formed. The protection layer 7 is formed by, for example, a plating method, a sputtering method, an evaporation method, a CVD (chemical vapor deposition) method or the like. When a DC sputtering method is applied, inside a chamber an argon (Ar) atmosphere of 0.5 Pa to 2 Pa may be used, for example. Further, a thickness of the protection layer 7 is set to be, for example, from 1 nm to 5 nm.

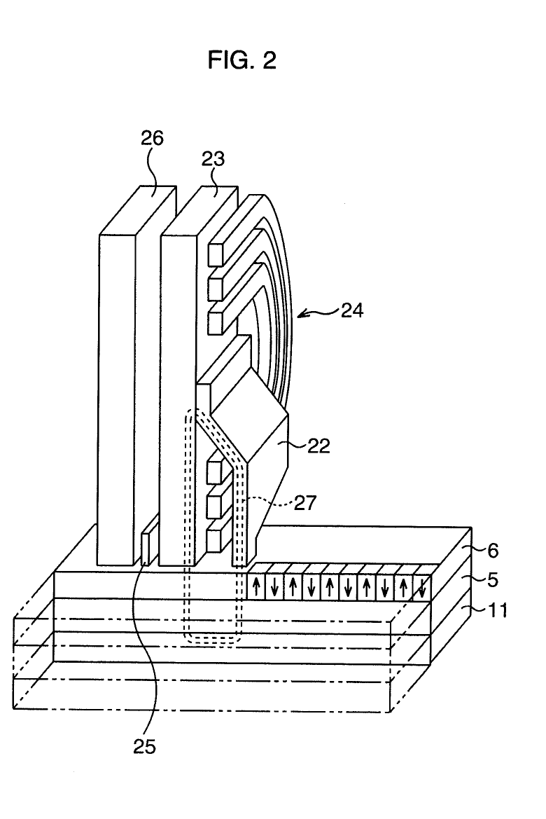

A magnetic head as shown in FIG. 2 is applied to the perpendicular magnetic recording medium constructed as such, for writing (recording) and reading (reproducing) data thereto and therefrom. A magnetic head 21 is provided with a main magnetic pole 22, an auxiliary magnetic pole 23 and a coil 24 to perform writing. It is further provided with a giant magnetoresistance effect element or a tunneling magneto resistance effect element 25 and a shield 26 to perform reading. The auxiliary magnetic pole 23 also functions as a shield to the magnetoresistance effect element 25. During the writing, a current is applied to the coil 24, which induces the magnetic flux 27 passing through the main magnetic pole 22 and the auxiliary magnetic pole 23. At this time, the magnetic flux 27 coming out of the main magnetic pole 22 passes through the recording layer 6, then goes back to the auxiliary magnetic pole 23 after passing through the soft under layer 11. Accordingly, a magnetization of the recording layer 6 is changed in its either vertical direction (either up or down) by every recording bit in accordance with a direction of the magnetic flux.

According to the embodiment as described above, since the thickness of the spacer layer 3 is set to a predetermined value, it is possible to obtain an advantage of the APS-SUL structure quite easily even when the thickness is changed a little during a manufacturing process. In other words, since the second smallest thickness (2nd APS) among the thicknesses corresponding to the peaks of the magnitude of the exchange magnetic field is adopted, it is possible not only to widen the range of the peak corresponding to the thickness of the spacer layer 3 but also to easily control the thickness thereof, which enables a direction of magnetization between the amorphous ferromagnetic layers 2 and 4 to be anti-parallel easily. It should be noted that, in a case the thickness of the spacer layer 3 does not correspond to the highest peak, there is a possibility that the direction of magnetization can not be perfectly anti-parallel. However, as long as the thickness of the spacer layer 3 is in a range corresponding to the peak, it is possible to obtain the advantage of the APS-SUL structure, that is, to achieve the object of the present invention. Specifically, even when the thickness of the spacer layer 3 does not correspond to the highest peak, as long as the 2nd APS is in a range corresponding to the peak, it is included in the technical scope of the present invention.

The thickness variation tolerance of the spacer layer 3 obtained from a graph shown in FIG. 3 is summarized as following table 1. Note that a value of spontaneous magnetization Bs is described for the purpose of reference.

TABLE 1

| Amorphous | Spontaneous | Tolerance of | Tolerance of |
|---|---|---|---|
| ferromagnetic | magnetization | the 1st APS | the 2nd APS |
| layer | Bs (T) | (nm) | (nm) |
| CoNbZr | 1.1 | 0.2 | — |
| FeCoB | 1.9 | 0.1 | 0.3 |
| FeCoBCr | 1.0 | 0.2 | 0.3 |

Further, comparing to a case when the 1st APS is adopted, the adoption of the 2nd APS requires the spacer layer 3 to increase the thickness thereof, which makes it possible to reduce the thickness of each the amorphous ferromagnetic layers 2 and 4. For example, when the thickness of the spacer layer 3 is set to be 0.4 nm (1st APS), the thickness of each the amorphous ferromagnetic layers 2 and 4 corresponding thereto is 25 nm. At the same time, if the thickness of the spacer layer 3 is set to be 1.9 nm (2nd APS), the similar exchange effect can be obtained by reducing the thickness of each the amorphous ferromagnetic layers 2 and 4 to 15 nm. This means that the total thickness of the perpendicular magnetic recording medium can be reduced.

Note that, instead of the disk-shaped substrate 1, a tape-shaped film can be used as a substrate. In this case, as a material of the substrate, polyester (PE), polyethylene telephthalate (PET), polyethylene naphthalate (PEN), polyimide (PI) having excellent heat resistance, and the like can be used.

Next, contents and results of an experiment actually conducted by the present inventors will be explained.

In the experiment, two kinds of samples are prepared. In each sample, an iron cobalt boron (FeCoB) layer having 25 nm in thickness is formed on a glass substrate as an amorphous ferromagnetic layer 2, a ruthenium (Ru) layer is formed as a spacer layer 3 and an iron cobalt boron (FeCoB) layer having 25 nm in thickness is formed as an amorphous ferromagnetic layer 4. Further, an intermediate layer 5 is formed on the amorphous ferromagnetic layer 4. For the intermediate layer 5 in one of the sample (first sample), a tantalum (Ta) layer, a nickel iron chromium (NiFeCr) layer and a ruthenium (Ru) layer having 25 nm in thickness are formed on the amorphous ferromagnetic layer 4. For the intermediate layer 5 in the other sample (second sample), a tantalum (Ta) layer, a nickel iron (NiFe) layer and a ruthenium (Ru) layer having 25 nm in thickness are formed on the amorphous ferromagnetic layer 4. Further, a recording layer 6 is formed on the intermediate layer 5. For the recording layer 6, a cobalt chromium platinum (CoCrPt)-silicon dioxide (SiO₂) layer having 11 nm in thickness is formed on the intermediate layer 5, and a cobalt chromium platinum boron (CoCrPtB) layer having 8 nm in thickness is formed thereon. The cobalt chromium platinum (CoCrPt)-silicon dioxide (SiO₂) layer is composed of a cobalt chromium platinum (CoCrPt) layer having a grain boundary where a lot of silicon dioxide (SiO₂) is precipitated therein. Then, a carbon (C) layer is formed on the recording layer 6 as a protection layer 7.

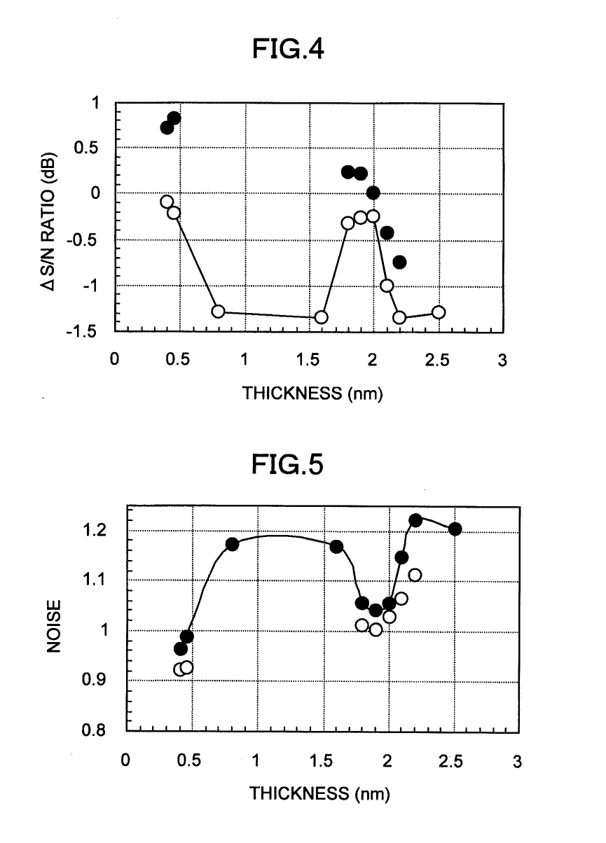

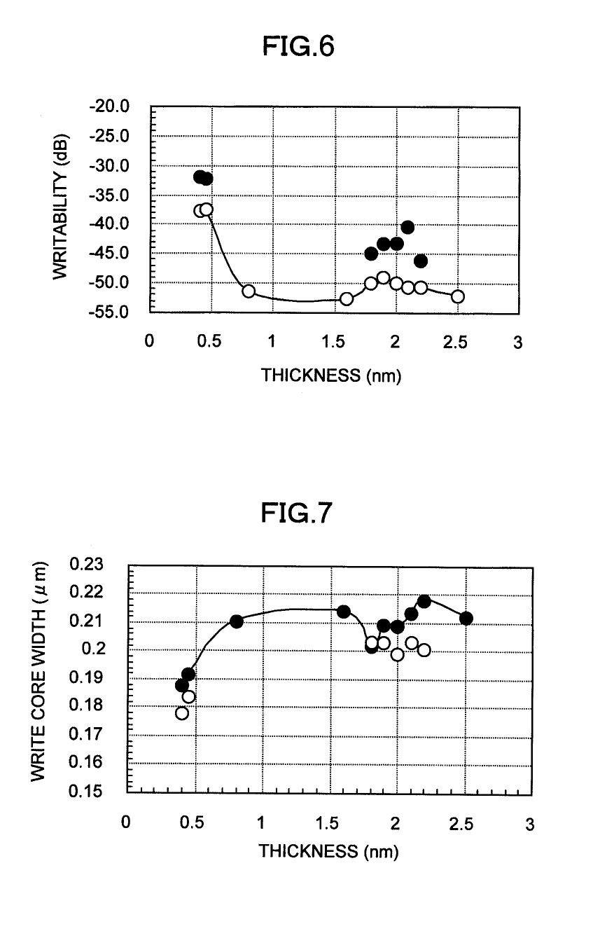

In each sample, a correlation of the thickness of the spacer layer 3 (ruthenium (Ru) layer) is examined with regard to an S/N ratio, a magnitude of noise, an over-writability (OW) and a write core width (WCW), respectively. These results are shown in FIG. 4, FIG. 5, FIG. 6 and FIG. 7, respectively. Note that “” and “◯” in FIGS. 4 to 7 indicate the results of the first sample and the second sample, respectively.

Regarding the S/N ratio, the highest peak is confirmed when the thickness of the spacer layer 3 is about 0.5 nm, and the second highest peak is appeared when the thickness of the spacer layer 3 is in a range of about 1.6 nm to 2.2 nm, as shown in FIG. 4. This means that the highest S/N ratio can be obtained at the 1st APS and the second highest S/N ratio can be obtained at the 2nd APS. However, these values show a small difference, and a sufficiently high S/N ratio is obtained at the 2nd APS. Note that ΔS/N value of the vertical axis in FIG. 4 indicates a difference of S/N ratio compared to that of an authentic sample in which a ruthenium (Ru) layer having 0.45 nm in thickness is formed for the spacer layer 3.

Further, regarding the magnitude of noise, a similar tendency to that of the S/N ratio is confirmed as shown in FIG. 5. That is, the smallest noise is observed at the 1st APS and the second smallest noise is observed at the 2nd APS. However, the difference of these values is also small and the noise is sufficiently minimized at the 2nd APS. Note that a noise value of the vertical axis in FIG. 5 indicates a value normalized by setting a magnitude of noise detected in the authentic sample having a ruthenium (Ru) layer of 0.45 nm in thickness for the spacer layer 3, as “1”.

The over-writability (OW) is evaluated by the difference detected by comparing a signal being read out when writing in 124 kBPI with a signal being read out when writing in 495 kBPI. It can be said that the smaller the difference of the values becomes, the more the over-writability (OW) is improved. As shown in FIG. 6, the better over-writability (OW) is obtained at the 2nd APS compared to the 1st APS, in each sample. The difference value therebetween is 8 dB to 10 dB, which is a quite preferable result.

The write core width (WCW) is measured by the signal level across the write track, is an index of how much width the writing is conducted. The WCW is partially affected by the grain size and distribution present in the media. As the value becomes smaller, it becomes possible to perform writing in a smaller region, which is preferable for the high-density recording. In other words, the smaller the write core width (WCW) is, the smaller the width of a recording track can be set. Although the write core width (WCW) of the 2nd APS is larger than that of the 1st APS as shown in FIG. 7, it is possible to meet the request.

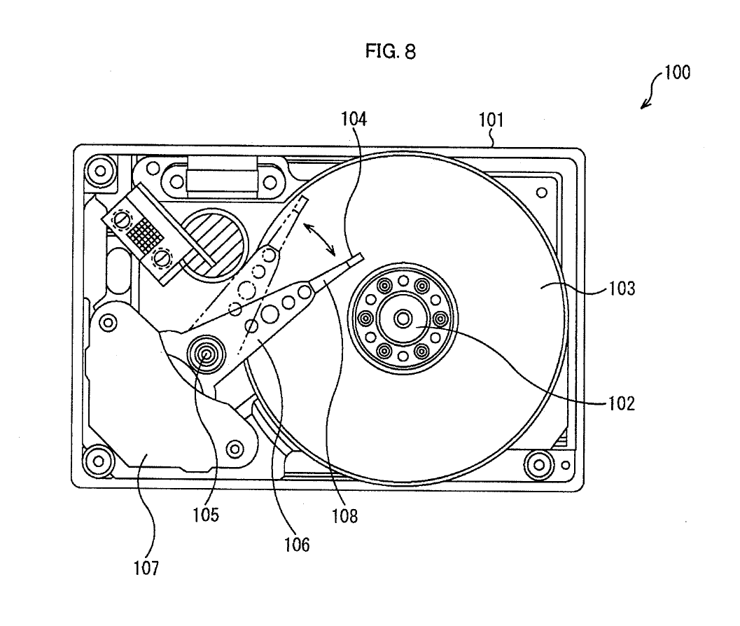

Here, a hard disk drive being an example of a magnetic recording device provided with a perpendicular magnetic recording medium according to the above-described embodiment will be explained. FIG. 8 is a view showing a structure inside the hard disk drive (HDD).

A hard disk drive 100 is provided with a housing 101. In the housing 101, a magnetic disk 103 attached to a rotation shaft 102 to be rotated, a slider 104 having a magnetic head mounted thereon for recording and reproducing information to and from the magnetic disk 103, a suspension 108 holding the slider 104, a carriage arm 106 having the suspension 108 fixed thereto and moving along a surface of the magnetic disk 103 with an arm shaft 105 as a center, and an arm actuator 107 driving the carriage arm 106 are housed. The perpendicular magnetic recording medium according to the above-described embodiment is used as the magnetic disk 103.

According to the present invention, since the thickness of the nonmagnetic metal layer is set to a suitable value with larger tolerance, even when the thickness varies a little during a manufacturing process, it is possible to easily make a structure of the soft under layer to be the APS-SUL structure and easily obtain an advantage thereof.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A perpendicular magnetic recording medium comprising:
a soft under layer; and
a recording layer formed above said soft under layer,
wherein said soft under layer includes:
an amorphous first ferromagnetic layer;
a nonmagnetic metal layer formed on said first ferromagnetic layer; and
an amorphous second ferromagnetic layer formed on an intermediate layer,
wherein a direction of magnetization between said first ferromagnetic layer and said second ferromagnetic layer is anti-parallel to each other;
wherein a magnitude of an exchange magnetic field between said first ferromagnetic layer and said second ferromagnetic layer shows a plurality of peaks as a thickness of said nonmagnetic metal layer increases, and
wherein the thickness of said nonmagnetic metal layer is defined to correspond to the second largest peak out of the plurality of peaks.

2. The perpendicular magnetic recording medium according to claim 1, further comprising an intermediate layer formed between said soft under layer and said recording layer.

3. The perpendicular magnetic recording medium according to claim 2, wherein said intermediate layer is composed of a nonmagnetic metal having a hexagonal close-packed crystal structure.

4. The perpendicular magnetic recording medium according to claim 2, wherein said intermediate layer is composed of ruthenium (Ru) or ruthenium (Ru) alloy.

5. The perpendicular magnetic recording medium according to claim 1, wherein said first ferromagnetic layer and said second ferromagnetic layer contain at least one element selected from a group consisting of iron (Fe), cobalt (Co) and nickel (Ni).

6. The perpendicular magnetic recording medium according to claim 5, wherein said first ferromagnetic layer and said second ferromagnetic layer further contain at least one element selected from a group consisting of chromium (Cr), boron (B), copper (Cu), titanium (Ti), vanadium (V), niobium (Nb), zirconium (Zr), platinum (Pt), palladium (Pd) and tantalum (Ta).

7. The perpendicular magnetic recording medium according to claim 1, wherein said nonmagnetic metal layer contains at least one element selected from a group consisting of ruthenium (Ru), copper (Cu) and chromium (Cr).

8. The perpendicular magnetic recording medium according to claim 7, wherein said nonmagnetic metal layer further contains at least one element selected from a group consisting of rhodium (Rh), rhenium (Re) and rare-earth metal.

9. The perpendicular magnetic recording medium according to claim 1, wherein a following formula of Mₛ₁×t₁=Mₛ₂×t₂ is satisfied where Mₛ₁ is a magnetization of said first ferromagnetic layer, t₁ is a thickness thereof, Mₛ₂ is a magnetization of said second ferromagnetic layer and t₂ is a thickness thereof.

10. The perpendicular magnetic recording medium according to claim 1, wherein a thickness of said nonmagnetic metal layer is 1 nm or more.

11. A manufacturing method of a perpendicular magnetic recording medium comprising the steps of:
forming a soft under layer; and
forming a recording layer above the soft under layer,
wherein the step of forming the soft under layer includes:
forming an amorphous first ferromagnetic layer;
forming a nonmagnetic metal layer on the first ferromagnetic layer; and
forming an amorphous second ferromagnetic layer on the nonmagnetic metal layer,
wherein a direction of magnetization between the first ferromagnetic layer and the second ferromagnetic layer is anti-parallel to each other,
wherein a magnitude of an exchange magnetic field between the first ferromagnetic layer and the second ferromagnetic layer shows a plurality of peaks as a thickness of the nonmagnetic metal layer increases, and
wherein the thickness of the nonmagnetic metal layer is defined to correspond to the second largest peak out of the plurality of peaks.

12. The manufacturing method of the perpendicular magnetic recording medium according to claim 11, further comprising the step of forming an intermediate layer on the soft under layer before said step of forming the recording layer,
wherein the recording layer is formed on the intermediate layer.

13. The manufacturing method of the perpendicular magnetic recording medium according to claim 12, wherein a nonmagnetic metal layer having a hexagonal close-packed crystal structure is formed as the intermediate layer.

14. The manufacturing method of the perpendicular magnetic recording medium according to claim 12, wherein a ruthenium (Ru) layer or a ruthenium (Ru) alloy layer is formed as the intermediate layer.

15. The manufacturing method of the perpendicular magnetic recording medium according to claim 11, wherein, as the first ferromagnetic layer and the second ferromagnetic layer, layers containing at least one element selected from a group consisting of iron (Fe), cobalt (Co) and nickel (Ni) are formed.

16. The manufacturing method of the perpendicular magnetic recording medium according to claim 11, wherein, as the nonmagnetic metal layer, a layer containing at least one element selected from a group consisting of ruthenium (Ru), copper (Cu) and chromium (Cr) is formed.

17. The manufacturing method of the perpendicular magnetic recording medium according to claim 16, wherein, as the nonmagnetic metal layer, a layer further containing at least one element selected from a group consisting of rhodium (Rh), rhenium (Re) and rare-earth metal is formed.

18. The manufacturing method of the perpendicular magnetic recording medium according to claim 11, wherein a following formula of Mₛ₁×t₁=Mₛ₂×t₂ is satisfied where Mₛ₁ is the magnetization of the first ferromagnetic layer, t₁ is the thickness thereof, Mₛ₂ is a magnetization of the second ferromagnetic layer and t₂ is the thickness thereof.

19. The manufacturing method of the perpendicular magnetic recording medium according to claim 11, wherein a thickness of the nonmagnetic metal layer is 1 nm or more.

20. A magnetic recording device comprising:
a perpendicular magnetic recording medium; and
a magnetic head recording and reproducing information to and from said perpendicular magnetic recording medium,
wherein said perpendicular magnetic recording medium comprises:
a soft under layer; and
a recording layer formed above said soft under layer,
wherein said soft under layer includes:
an amorphous first ferromagnetic layer;
a nonmagnetic metal layer formed on said first ferromagnetic layer; and
an amorphous second ferromagnetic layer formed on an intermediate layer,
wherein a direction of magnetization between said first ferromagnetic layer and said second ferromagnetic layer is anti-parallel to each other;
wherein a magnitude of an exchange magnetic field between said first ferromagnetic layer and said second ferromagnetic layer shows a plurality of peaks as the thickness of said nonmagnetic metal layer increases, and
wherein the thickness of said nonmagnetic metal layer is defined to correspond to the second largest peak out of the plurality of peaks.
